(19) United States
(12) Patent Application Publication
(10) Pub. No.: US 2006/0220999 A1
(43) Pub. Date: Oct. 5, 2006

(54) Scan drive circuit for plasma display panel, driving circuit for plasma display panel and plasma display apparatus using same

(75) Inventor: Tae Hyung Kim, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/390,300

(22) Filed: Mar. 28, 2006

(30) Foreign Application Priority Data
Mar. 29, 2005 (KR) 10-2005-0025791

(51) Int. Cl. G09G 3/28

(52) U.S. Cl. 345/68

(57) ABSTRACT

A scan drive circuit is provided for a plasma display panel (PDP). The scan drive circuit may reduce a number of switching elements by having one scan electrode correspond to a single switching element, thereby reducing the manufacturing cost of the plasma display panel driving circuit and the plasma display apparatus.

This application claims priority from Korean Patent Application No. 10-2005-0025791, filed on Mar. 29, 2005 in the Korean Intellectual Property Office (KIPO), the entire contents of which are hereby incorporated by reference.

### BACKGROUND OF THE INVENTION

1. Field of the Invention

Embodiments of the present invention relate to a plasma display panel.

2. Background of the Related Art

Plasma display panels (PDP) are considered a next-generation flat plate display device. The plasma display panel may provide a thin and large-sized screen, and is widely applied for wall-mounted televisions, home theater displays, workstation monitors, and/or etc.

### SUMMARY OF THE INVENTION

An object of the present invention is to provide a scan drive circuit for a plasma display panel, a drive circuit for the plasma display panel and a plasma display apparatus using the same, which can reduce the number of switching elements constituting a scan drive circuit for driving a plasma display panel (PDP) so that one scan electrode corresponds to a single switching element, thereby reducing manufacturing cost.

According to one aspect of the present invention, a PDP driving circuit is provided that includes a scan-up unit, a scan-down unit and a scan driver.

The scan-up unit outputs a higher voltage level (e.g., reference voltage) out of two voltage levels of a predetermined scan pulse (or signal or waveform) to a predetermined node in a period corresponding to the higher voltage level, the scan pulse being supplied to a plurality of Y electrodes. The scan-up unit includes a switching element that enables the reference voltage to be applied to the node in the period corresponding to the higher voltage level according to a predetermined control signal. The scan-up unit may further include an element that applies a voltage, which is higher than the reference voltage, to the node so as to block a current flowing in a direction opposite to a direction in which the reference voltage is applied.

The scan-down unit outputs a lower voltage level (e.g., scan voltage) out of two voltage levels of the predetermined scan pulse to the node in a period corresponding to the lower voltage level. The scan-down unit may include a switching element that performs a switching operation so as to enable the scan voltage to be applied to the node in the period corresponding to the lower voltage level.

The scan driver supplies the scan pulse, which is formed with the reference voltage and the scan voltage, to the Y electrodes. The scan driver may further include a diode that is connected in parallel to the respective switching elements for switching the scan voltage to the Y electrodes, in accordance with the control signal, so as to supply the reference voltage to the Y electrodes.

The scan driver may be formed with at least one integrated circuit (IC) that is connected to some of the plurality of Y electrodes. The switching elements may include an N-type metal oxide semiconductor (MOS) transistor (NMOST) or an insulated gate bipolar transistor (IGBT). The diode may be designed as an independent circuit in one area on the integrated circuit or may be formed parasitically when designing the switching elements.

The reference voltage may be 10 volts or 0 volts, for example.

According to another aspect of the present invention, a drive circuit is provided for a plasma display panel that includes a scan-up unit configured to output a higher voltage level (e.g., reference voltage) out of two voltage levels of a predetermined scan pulse (or signal or waveform) to a plurality of Y electrodes of the plasma display panel. The drive circuit may also include a scan-down unit configured to output a scan voltage that corresponds to a lower voltage level, in a period corresponding to the lower level of the scan pulse. Still further, the drive circuit may also include a plurality of switching elements that correspond to the plurality of Y electrodes in a ratio of 1:1. The switching elements may selectively output one of the reference voltage and scan voltage to the plurality of Y electrodes in accordance with a predetermined control signal, and generate the scan pulse(s).

According to another aspect of the present invention, a plasma display apparatus is provided that includes a PDP driving circuit to enable an image corresponding to a predetermined image signal to be perceived visually.

According to another aspect of the present invention, a scan drive circuit is provided for a plasma display panel that is connected to at least one Y electrode of the plasma display panel for supplying a predetermined set-up voltage, a sustain pulse (or signal or waveform) and a scan pulse (or signal or waveform). The scan drive circuit may include at least one diode that forms a path for a reference voltage, the set-up voltage and the sustain pulse, respectively, the reference voltage being a higher level out of two voltage levels of the scan pulse. The scan drive circuit may further include at least one switching element that is connected in parallel to the respective diodes to form the scan pulse in a separate scan period of the respective Y electrodes by switching to a lower voltage level of the scan pulse in accordance with a predetermined control signal, and corresponding to the respective Y electrodes.

The least one switching element and the least one diode included in the scan drive circuit may be integrated on one semiconductor chip.

### BRIEF DESCRIPTION OF THE DRAWINGS

Embodiments of the present invention will be described in detail with reference to the following drawings in which like reference numerals refer to like elements and wherein:

FIG. 1 is a circuit diagram illustrating a scan drive circuit for supplying driving signals to a PDP.

FIG. 2 is a block diagram illustrating a part of a plasma display apparatus according to one exemplary embodiment of the present invention.

FIG. 3 is a waveform illustrating a voltage of a scan electrode Y of a plasma display panel according to the exemplary embodiment of the present invention.

FIG. 4 is a circuit diagram illustrating a PDP driving circuit according to a first exemplary embodiment of the present invention.

FIG. 5 is a circuit diagram illustrating a PDP driving circuit according to a second exemplary embodiment of the present invention.

FIG. 6 is a circuit diagram illustrating a PDP driving circuit according to a third exemplary embodiment of the present invention.

FIG. 7 is a circuit diagram illustrating a PDP driving circuit according to a fourth exemplary embodiment of the present invention.

### DETAILED DESCRIPTION OF PREFERRED EMBODIMENTS

Various plasma display apparatus and driving methodology are described in U.S. patent application Ser. No. 11/330,995, filed Jan. 13, 2006; Ser. No. 11/281,439, filed Mar. 18, 2005; Ser. No. 11/325,333, filed Jan. 5, 2006; and Ser. No. 11/249,278, filed Feb. 8, 2006, the subject matters of which are incorporated herein by reference.

The following discussion may refer to a pulse(s), a waveform(s) and/or a signal(s). These terminologies may be interchangeable.

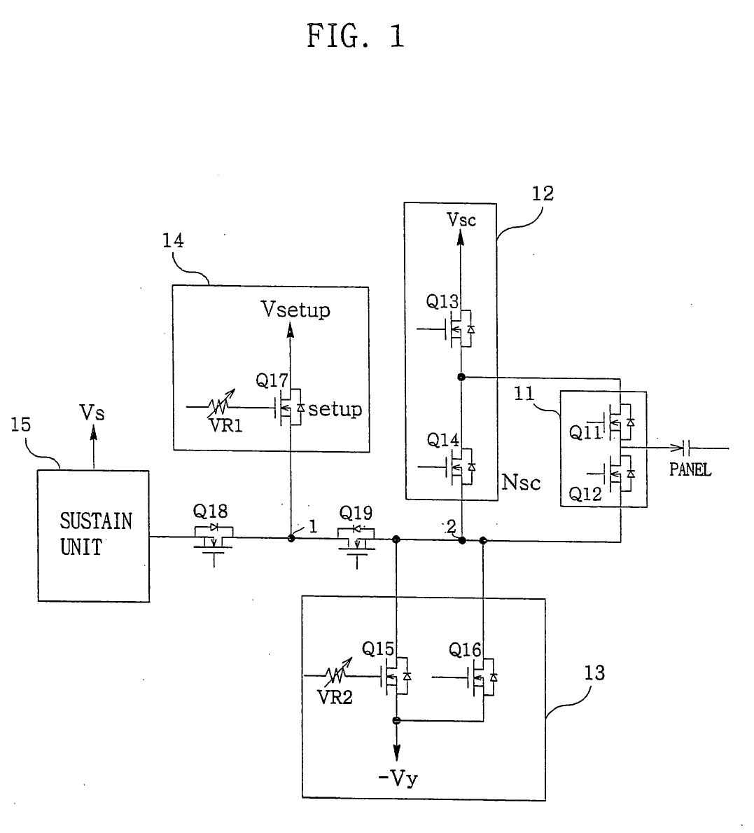

FIG. 1 is a circuit diagram illustrating a scan drive circuit for supplying driving signals to a PDP. In FIG. 1, the PDP driving circuit includes a drive integrated circuit (IC 11), a scan-up unit 12, a scan-down unit 13, a set-up supplying unit 14 and a sustain unit 15.

The drive IC 11 has output terminals that correspond to a number of scan electrodes of the PDP. For example, if the number of scan electrodes is 728, then the number of output terminals should be 728. In this case, if the drive IC 11 has 64 output terminals, approximately 12 drive ICs 11 are required. An inner circuit of one drive IC 11 includes two transistors Q11 and Q12 that are connected in a push-pull manner.

The PDP is driven by supplying scan electrodes with different waveforms (or signals or pulses) in accordance with each time divided into a reset period, an address period, a sustain period and an erase period.

The drive IC 11 is set to operate in the scan period (i.e., the address period). In the reset period, the sustain period and the erase period, a transistor Q12 of the drive IC 11 maintains a turned-on state to provide a set-up voltage or a set-down voltage to the scan electrode.

In the scan period, a pulse (or signal or waveform) that repeats a reference voltage Vsc and a scan voltage −Vy is applied to the scan electrodes. Accordingly, in the drive IC 11, the reference voltage Vsc is applied to a drain terminal of the transistor Q11 via a transistor Q13, and the scan voltage −Vy is applied to a source terminal of the transistor Q12 via a transistor Q16.

At the beginning of the scan period, the transistors Q11 and Q12 of the drive IC 11 are repeatedly turned on and turned off so as to apply the scan voltage to the scan electrode whenever a voltage applied to the scan electrode is changed from the reference voltage Vsc to the scan voltage −Vy, or from the scan voltage −Vy to the reference voltage Vsc.

The set-up supplying unit 14 supplies a set-up voltage of the set-up period, and the sustain unit 15 supplies a sustain voltage.

The drive IC 11 of the PDP driving circuit basically includes two transistors per scan line, thereby allowing the number of drive ICs each corresponding to scan lines to be increased.

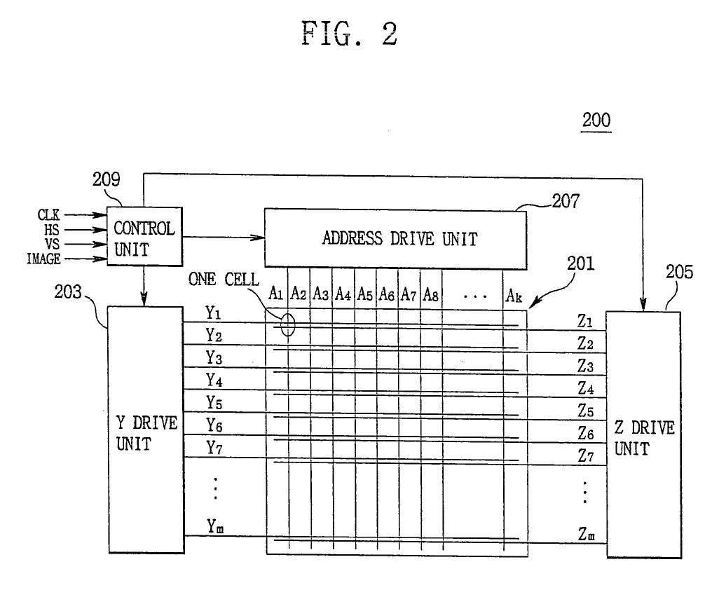

FIG. 2 is a block diagram illustrating a part of a plasma display apparatus according to one exemplary embodiment of the present invention. Referring to FIG. 2, a display apparatus 200 of a tri-electrode surface discharge plasma display panel (hereafter referred to as “PDP”) will now be briefly explained. The display device 200 shown in FIG. 2 does not show a part for receiving and processing a broadcasting signal as well as other possible components, and the explanation thereof will thereby be omitted.

According to one embodiment of the present invention, the PDP display apparatus 200 includes a plasma display panel (PDP) 201, a Y driving unit 203, a Z driving unit 205, an address driving unit 207 and a control unit 209.

The PDP 201 includes m number of Y electrodes (Y₁˜Yₘ) and Z electrodes that are arranged alternately one by one in parallel to each other. The Y electrodes (Y₁˜Yₘ) are referred to as a scan electrode, and the Z electrodes (Z₁˜Zₘ) are referred to as a common electrode.

Additionally, the PDP 201 includes k number of address electrodes (A₁˜Aₖ) that are arranged perpendicular to each Y electrode and Z electrode and to run parallel to each other while being spaced apart by a uniform distance. A cell is formed on each intersection that m number of Y electrodes and Z electrodes and K number of address electrodes are crossed. According to this structure, a whole screen is formed with R (Red), G (Green) and B (Blue) cells of a matrix type.

The Y driving unit 203 corresponds one to one with the Y electrodes of the PDP 201 so as to supply a sustain pulse (or signal or waveform) and a scan pulse (or signal or waveform) to the scan electrodes (i.e., Y electrodes (Y₁˜Yₘ)).

The Z driving unit 205 corresponds one to one with the Z electrodes of the PDP 201 so as to supply the sustain pulse and the scan pulse to the Z electrodes (Z₁˜Zₘ).

The address driving unit 207 corresponds one to one with the address electrodes (A₁˜Aₖ) of the PDP 201 so as to supply a writing pulse (or signal or waveform) to the respective address electrodes (A₁˜Aₖ).

The control unit 209 digitizes an analog image signal (IMAGE) that is inputted from an external source to output a digital image signal. Additionally, the control unit 209 produces various control signals in accordance with an external input signal such as a clock (CLK), a horizontal sync signal (HS), a vertical sync signal (VS), and others, so as to control the Y driving unit 203, the Z driving unit 205 and the address driving unit 207.

Hereafter, among the driving units 203, 205 and 207 of the PDP 201, operations of the Y driving unit 203 will be explained.

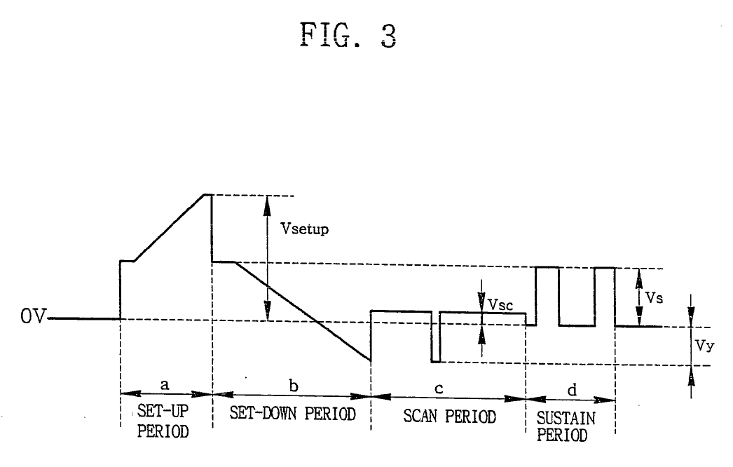

An output waveform (or signal or pulse) of the Y driving unit 203 is explained with reference to FIG. 3. A driving power supply corresponding to a waveform (or signal or pulse) of FIG. 3 is applied to the respective Y electrodes (Y₁˜Yₘ). In a set-up period (a), a set-up voltage Vsetup is applied to the Y electrodes. In a set-down period (b) after the set-up voltage Vsetup is applied, a voltage, which is applied to the Y electrodes, falls (or decreases) from the set-up voltage Vsetup to a scan voltage −Vy.

Successively, in the address period (i.e., the scan period (c)), the voltage applied to the Y electrodes is a scan pulse (or signal or waveform) that switches from the reference voltage Vsc to the scan voltage −Vy. The point in time when the reference voltage Vsc is switched to the scan voltage −Vy varies for every Y electrode. In other words, a period, over which the scan voltage −Vy is maintained, is varied for every Y electrode, and substantially becomes separate scan period of corresponding Y electrodes. Also, the scan pulse is a waveform of separate scan period. Accordingly, the scan period (c) of FIG. 3 is the sum of the separate scan periods for all Y electrodes (Y₁˜Yₘ). For convenience of explanation, the scan period (c) excluding the separate scan period is explained below.

The reference voltage Vsc and the scan voltage −Vy may have various voltage levels according to characteristics of the PDP 201. The reference voltage Vsc may be about 10 volts and the scan voltage −Vy may be about −100 volts. Other voltage values may also be provided.

In the sustain period (d), a sustain pulse (or signal or waveform) for a sustain discharge is applied to the Y electrodes.

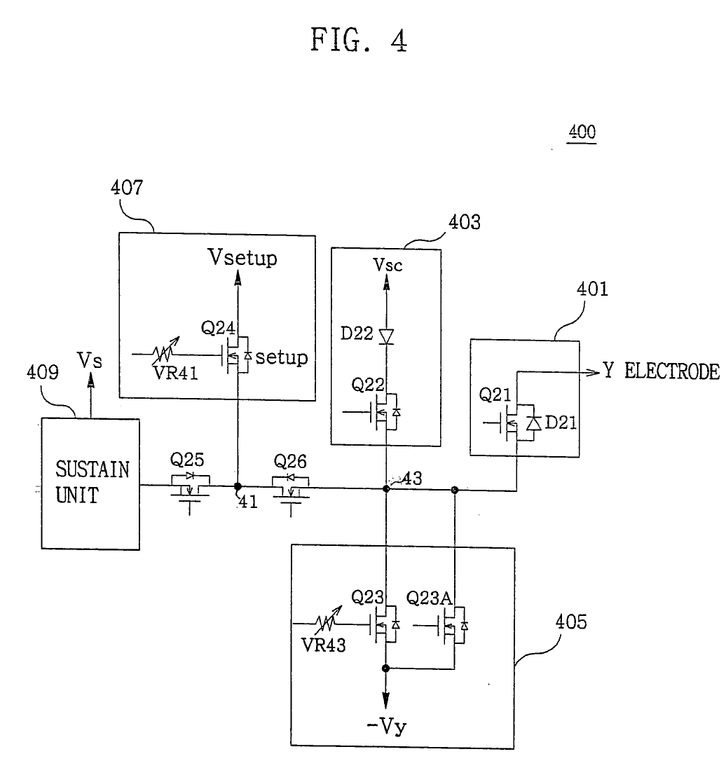

Operations of the PDP driving circuit in the scan period according to various embodiments of the present invention will be explained with reference to FIGS. 4 to 7. The PDP driving circuit includes a scan driver that operates in the scan period (c). The scan driver is configured to enable one Y electrode to correspond to one switching element.

FIG. 4 is a circuit diagram illustrating a PDP driving circuit 400 according to a first exemplary embodiment of the present invention. Other embodiments and configurations are also within the scope of the present invention.

The driving circuit 400 according to the first embodiment of the present invention corresponds to the Y driving unit 203 and supplies a predetermined driving power source to the Y electrodes (Y₁˜Yₘ) of the PDP 201.

The PDP driving circuit 400 includes a scan driver 401, a scan-up unit 403, a scan-down unit 405, a set-up pulse supplying unit 407, a sustain pulse supplying unit 409, a switch Q25 and a switch Q26. An output of the scan driver 401 is connected to the Y electrodes (Y₁˜Yₘ). Operations of the scan driver 401 will hereafter be explained.

The switches Q21 to Q26 included in the PDP driving circuit 400 may be configured of various elements such as a metal oxide semiconductor (MOS), an insulated gate bipolar transistor (IGBT), and/or etc. Additionally, the switches Q21 to Q26 may equivalently include an inner diode formed parasitically. For convenience of explanation and understanding, FIG. 4 shows both the respective switches and their inner diodes that are not indicated by a reference number. Alternatively, the switches may also be designed by including an actual diode.

The scan driver 401 includes m number of switches that correspond to the respective Y electrodes (Y₁˜Yₘ). The m number of switches are respectively connected in parallel to a node 43. The m numbers of switches are also respectively connected in parallel to the diode. A diode that is connected in parallel to a switch may not use an inner diode, but rather may be a separate diode.

Drain terminals that are the outputs of each switch included in the scan driver 401 are respectively connected to a corresponding Y electrode. Accordingly, the driving circuit 400 includes one or more scan drivers 401 having m number of output terminals corresponding to the Y electrodes (Y₁˜Yₘ) so as to enable the scan drivers 401 to be mapped to the Y electrodes (Y₁˜Yₘ).

The scan driver 401 may be manufactured by a semiconductor process as an integrated circuit (IC), for example.

FIG. 4 shows a representative switch Q21 included in the scan driver 401 and a representative diode D21 connected in parallel to the switch Q21. The switch Q21 is connected to a Y electrode as an open-drain. The scan driver 401 may drive the Y electrodes by on/off operations of the switch Q21.

The scan driver 401 receives a desired voltage signal from a scan-up unit 403, a scan-down unit 405, a set-up pulse supplying unit 407 and a sustain pulse supplying unit 409.

In the scan period (c), the reference voltage Vsc is applied to the node 43 from the scan-up unit 403. This reference voltage Vsc is also applied to the Y electrodes via an inner diode of the switch Q21 and a diode D21. At this time, the switch Q21 is in a turned-off state.

If the voltage of the Y electrodes falls (or decreases) from the reference voltage Vsc to the scan voltage −Vy, switches Q23A and Q21 are turned on by a desired control signal, and simultaneously, the scan voltage −Vy is applied to the Y electrodes.

In all periods, except for the scan period (c), the switch Q21 is maintained in the turn-off state.

The scan-up unit 403 includes a diode D22 and a switch Q22. An anode of the diode D22 is connected to the reference voltage Vsc, and the switch Q22 is connected in series to a cathode of the diode D22.

The switch Q22 is turned on by the desired control signal for the scan period (c), and applies the reference voltage Vsc to the scan driver 401 via the diode D22. If the switch Q22 is turned off, the reference voltage Vsc that is applied to the scan driver 401 is blocked. Even if the switch Q22 is turned off, the reference voltage Vsc may be maintained as it is between presently non-scanned Y electrodes and corresponding Z electrodes. The desired control signal supplied to the switch Q22 may be supplied from a timing controller (not shown).

The scan-down unit 405 includes a switch Q23 and a switch Q23A. In the switch Q23, the voltage applied to the scan driver 401 falls (or decreases) slowly from the set-up voltage Vsetup to the scan voltage −Vy for the set-down period. The scan voltage −Vy is used as the set-down voltage. Meanwhile, in the switch Q23A, the reference voltage Vsc applied from the scan-up unit 403 falls (or decreases) exponentially to the scan voltage −Vy for the scan period (c).

The set-up pulse supplying unit 407 includes a switch Q24 that is connected in series to the set-up voltage Vsetup. In the set-up period, the switch Q24 is operated by the desired control signal so as to apply the set-up voltage Vsetup to the scan driver 401.

The sustain unit 409 generates and outputs a sustain pulse (or waveform or signal) so as to enable screen brightness to be controlled.

A voltage charged to the sustain unit 409 is outputted to the scan driver 401 via switches Q25 and Q26. Accordingly, the scan driver 401 supplies an applied voltage from the sustain unit 409 to the Y electrodes.

If a sustain voltage Vs from a desired voltage source (not shown) is applied to the scan driver 401 via the inner diode of the switches Q25 and Q26, the scan driver 401 supplies the applied sustain voltage to the Y electrodes so as to enable a voltage level on the Y electrodes to be maintained by the sustain voltage Vs, thereby causing discharge cells to be sustain-discharged.

Operations of the PDP driving circuit 400 according to first exemplary embodiment of the present invention will now be explained. In the set-up period (a), if the switches Q24 and Q25 are turned on, the sustain voltage Vs is applied from the sustain unit 409. The applied sustain voltage Vs is supplied to respective Y electrodes (Y₁˜Yₘ) via the inner diode of the switch Q25, the diode D21 of the switch Q26 included in the scan driver 401, and the inner diode of the switch Q21. The voltage of the Y electrodes (Y₁˜Yₘ) exponentially rises (or increases) to the sustain voltage Vs, similar to the beginning of the set-up period (a) of FIG. 3. As a result, image data on the PDP 201 may be erased and the following image data may be prepared.

Meanwhile, the set-up voltage Vsetup is applied to a drain terminal of the switch Q24. As the switch Q24 whose channel width is controlled by a variable resistor (VR) 41 is used, the voltage of the node 41 rises (or increases) with a predetermined slope so as to reach the set-up voltage Vsetup. Accordingly, the PDP driving circuit 400 supplies the set-up voltage for the set-up period (a). The set-up voltage is applied to the respective Y electrodes (Y₁˜Yₘ) via the switch Q26, the diode D21 of the scan driver 401, and the inner diode of the switch Q21. Thus, a voltage of a ramp-up pulse (or signal or waveform) is applied to the Y electrodes (Y₁˜Yₘ).

After the voltage of the ramp-up pulse (or signal or waveform) is applied to the Y electrodes (Y₁˜Yₘ), the switch Q24 is turned off. If the switch Q24 is turned off, only the sustain voltage Vs supplied from the sustain unit 409 is applied to the node 41 so that the voltage of the Y electrodes (Y₁˜Yₘ) exponentially falls (or decreases) to the sustain voltage Vs.

In the set-down period (b), the switch Q26 is turned off and the switch Q23 is turned on. The channel width of the switch Q23 is controlled by a variable resistor VR 43 so that the voltage of the node 43 falls (or decreases) with the predetermined slope and thus falls (or decreases) to the scan voltage −Vy. At this time, a voltage of a ramp-down pulse (or signal or waveform) is applied to the respective Y electrodes (Y₁˜Yₘ).

In the scan period (c), the reference voltage Vsc is applied to the node 43 via the diode D22 and the switch Q22. The reference voltage Vsc is also applied to the Y electrodes (Y₁˜Yₘ) via the diode D21 and the inner diode of the switch Q21. At this time, the switch Q21 is in a turned-off state.

If the voltage of the Y electrodes (Y₁˜Yₘ) falls (or decreases) from the reference voltage Vsc to the scan voltage −Vy, the switches Q23A and Q21 are turned on by the predetermined control signal so as to apply the scan voltage −Vy to the Y electrodes (Y₁˜Yₘ).

In the sustain period (d), the sustain pulse (or signal or waveform) of the sustain unit 409 is outputted to the PDP 201 so as to enable the screen brightness to be controlled.

The PDP driving circuit 400 according to the first exemplary embodiment of the present invention may be operated thorough the above-described processes. The diode D22 may be designed using switching elements.

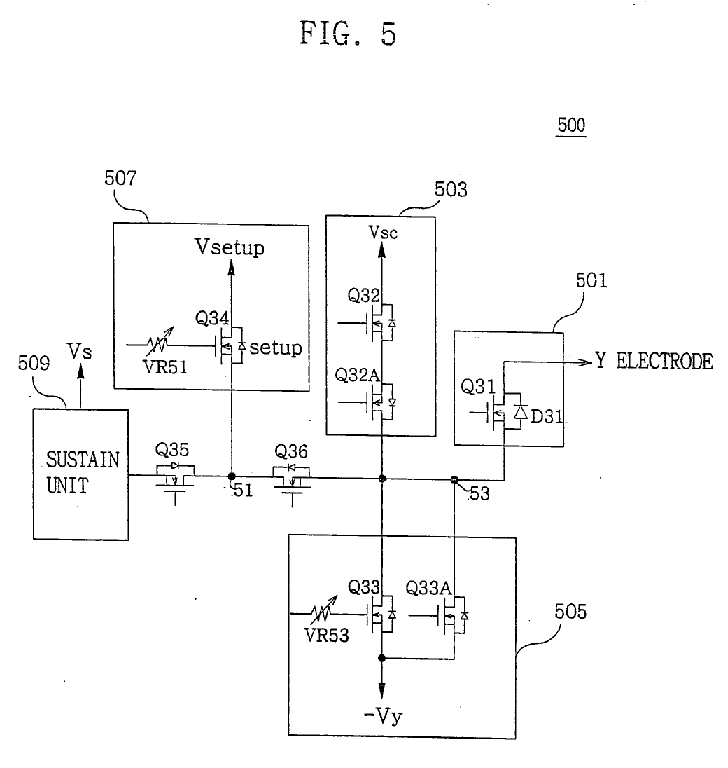

FIG. 5 is a circuit diagram illustrating a PDP driving circuit 500 according to a second exemplary embodiment of the present invention. Other embodiments and configurations are also within the scope of the present invention.

As shown in FIG. 5, the PDP driving circuit 500 includes a scan driver 501, a scan-up unit 503, a scan-down unit 505, a set-up pulse supplying unit 507, a sustain unit 509, a switch Q35 and a switch Q36.

The PDP driving circuit 500 includes the same elements as the PDP driving circuit 400 except that the scan-up unit 503 includes a switch Q32A while the scan-up unit 403 includes the diode D22. The switch Q32A is a common-source type, but is not limited thereto. Since the scan-up unit 503 uses the switch Q32A instead of the diode D22, when the reference voltage Vsc is applied, a voltage level of the node 43 may stably be maintained according to bidirectional characteristics of the switch Q32A.

FIG. 5 shows a representative switch Q31 and a representative diode D31 connected in parallel to the switch Q31, all of which are included in the scan driver 501. The switch Q31 is a open-drain type and connected to the Y electrodes. The scan driver 501 can drive the Y electrodes by on/off operations of the switch Q31.

The scan driver 501 receives a signal of a predetermined voltage from the scan-up unit 503, the scan-down unit 505, the set-up pulse supplying unit 507 and the sustain unit 509.

In the scan period (c), the reference voltage Vsc is supplied through the node 53 from the scan-up unit 503. The reference voltage Vsc is applied to the Y electrodes via the diode D31 and an inner diode of the switch Q31. At this time, the switch Q31 is in a turned-off state.

If the voltage of the Y electrodes falls (or decreases) from the reference voltage Vsc to the scan voltage −Vy, the switches Q33A and Q31 are turned on by the predetermined control signal so as to enable the scan voltage −Vy to be applied to the Y electrodes.

In periods other than the scan period (c), the switch Q31 is maintained in the turn-off state.

The PDP driving circuit 500 according to a second exemplary embodiment of the present invention is operated through the above-described processes.

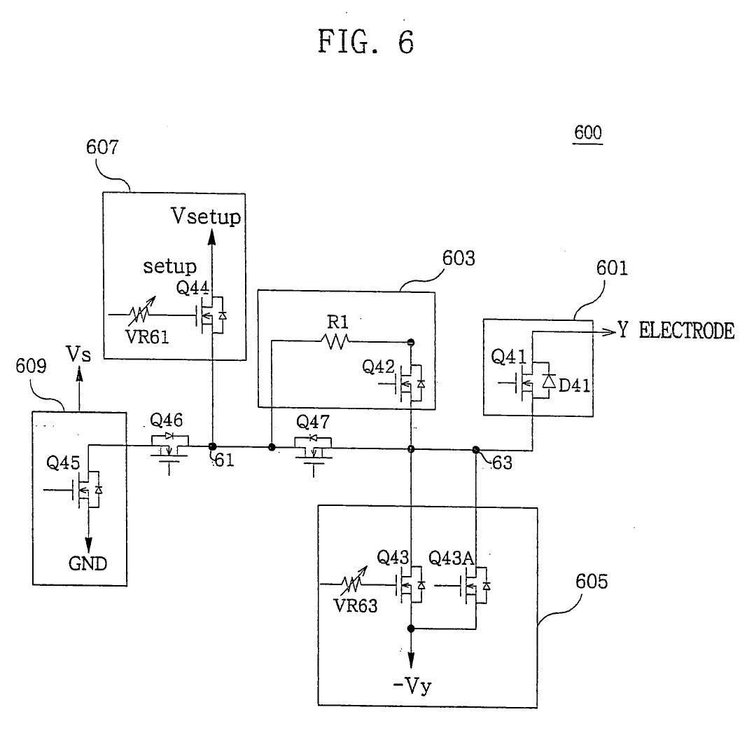

FIG. 6 is a circuit diagram illustrating a PDP driving circuit 600 according to a third exemplary embodiment of the present invention. Other embodiments and configurations are also within the scope of the present invention.

As shown in FIG. 6, the PDP driving circuit 600 includes a scan driver 601, a scan-up unit 603, a scan-down unit 605, a set-up pulse supplying unit 607, a sustain unit 609, a switch Q46 and a switch Q47.

The PDP driving circuit 600 includes the same elements as the PDP driving circuit 400 of FIG. 4, except that configuration of the scan-up unit 603 is different from the configuration of the scan-up unit 403 of FIG. 4. However, a signal waveform, which is outputted to the Y electrodes by operation of the scan-up unit 603, may be identical (or substantially identical) with the waveform shown in FIG. 3.

The reference voltage Vsc is not applied from the external source in the scan-up unit 603. The scan-up unit 603 includes a resistor R41 and a switch Q42 that are connected in series to each other, and are connected in parallel to a switch Q47.

In the scan period, if the switch Q42 is turned on by the predetermined control signal, a voltage of a node 63 connected to the scan driver 601 rises (or increases) from the scan voltage to a ground potential (i.e., 0 volts). At that time, if the corresponding Y electrodes are scanned, the switch Q42 is turned off and the switch Q43A of the scan-down unit 605 is turned on so that the scan voltage −Vy is applied to the Y electrodes. Accordingly, in contrast to the waveform shown in the scan period (c) of FIG. 3, a waveform, which is changed between the ground potential (i.e., 0 volts) and the scan voltage −Vy, is supplied to the Y electrodes. In other words, the reference voltage of the scan pulse (or signal or waveform) may become 0 volts rather than Vsc.

In the scan pulse (or signal or waveform) of the scan period (c), a voltage difference between the reference voltage and the scan voltage −Vy is important. The voltage difference varies according to characteristics of the PDP. If the driving circuit 600 of FIG. 6 is applied to a PDP having the same characteristics as the PDP that is provided with the driving circuits 400 and 500 of FIG. 5, the scan voltage −Vy may be −110 volts. Additionally, if the driving circuit 600 of FIG. 6 is applied to a PDP having different characteristics, the scan voltage −Vy may not be −110 volts but rather may be a different voltage.

FIG. 6 shows a representative switch Q41 and a representative diode D41 connected in parallel to the switch Q41, all of which are included in the scan driver 601. The switch Q41 is an open-drain type and is connected to the Y electrodes. The scan driver 601 can drive the Y electrodes by on/off operations of the switch Q41.

The scan driver 601 receives a signal of a predetermined voltage from the scan-up unit 603, the scan-down unit 605, the set-up pulse supplying unit 607 and the sustain unit 609.

At the beginning of the scan period (c), the switch Q41 is in a turned-off state, and the ground potential is supplied to a node 63 from the scan-up unit 603.

If the voltage of the Y electrodes falls (or decreases) from the ground potential voltage to the scan voltage −Vy, the switches Q43A and Q41 of the scan-down unit 605 are turned on by the predetermined control signal so as to enable the scan voltage −Vy to be applied to the Y electrodes.

In all periods other than the scan period (c), the switch Q41 is maintained in the turned-off state.

The PDP driving circuit 600 according to the third exemplary embodiment of the present invention is operated through the above-described processes.

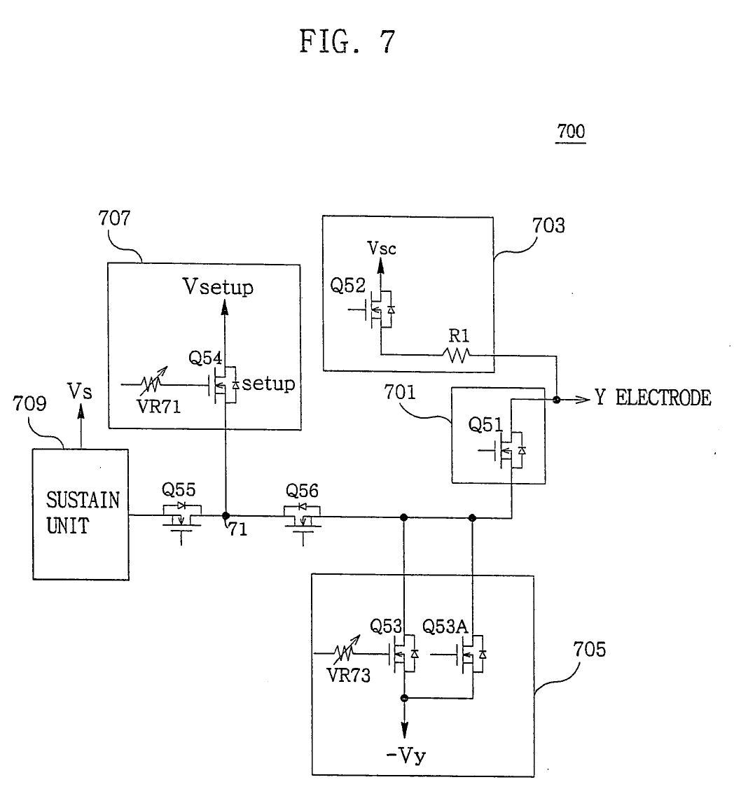

FIG. 7 is a circuit diagram illustrating a PDP driving circuit according to a fourth exemplary embodiment of the present invention. Other embodiments and configurations are also within the scope of the present invention.

As shown in FIG. 7, the PDP driving circuit 700 includes a scan driver 701, a scan-up unit 703, a scan-down unit 705, a set-up pulse supplying unit 707, a sustain unit 709, a switch Q55, and a switch Q56.

The PDP driving circuit 700 includes the same elements as the PDP driving circuit 400 of FIG. 4, except that configuration of the scan-up unit 703 is different from the configuration of the scan-up unit 403 of FIG. 4. However, a signal waveform that is outputted to the Y electrodes by operation of the scan-up unit 703 may be identical (or substantially identical) with the waveform shown in FIG. 3.

The scan-up unit 703 includes a switch Q52 and a resistor R1, all of which are connected in series to each other. A drain terminal of the switch Q52 is connected to the reference voltage Vsc, and one terminal of the resistor R1 is connected to an output of the scan driver 701.

If the switch Q52 is turned on by a predetermined control signal, the reference voltage Vsc is applied to the scan driver 701. If the switch Q52 is turned off by a predetermined control signal, the reference voltage Vsc is blocked.

In the scan period (c), if the reference voltage Vsc is required for the Y electrodes, the switch Q51 is maintained in the turned-off state, so that the reference voltage Vsc applied from the switch Q52 is applied to the Y electrodes. Next, at the point of time when the reference voltage Vsc is changed to the scan voltage −Vy, if the switch Q51 and the switch Q53A are turned on, the scan voltage −Vy is applied to the Y electrodes in spite of the reference voltage Vsc.

Accordingly, for the scan period (c) both the switch Q52 included in the scan-up unit 703 and the switch Q53A included in the scan-down unit 705 are maintained in the turned-on state, and the scan pulse (or signal or waveform) may be generated by operations of the switch Q51.

If the scan processes are completed, a pulse (or signal or waveform) of the sustain unit 709 is outputted to the PDP thereby allowing the screen brightness of the PDP to be controlled.

The PDP driving circuit 700 according to a fourth exemplary embodiment of the present invention is operated through the above-described processes.

As described above, the PDP driving circuit according to embodiments of the present invention may include a single switching element in comparison with a scan driver having a pair of switching elements in order to drive the PDP, thereby allowing the number of switching elements and manufacturing cost to be reduced.

Embodiments of the present invention may be implemented by a method, a device and a system.

If the invention is implemented by computer software for simulation, and the like, elements of embodiments of the present invention may be replaced with a code segment required for performing necessary operations. Programs or code segments may be stored in the media that can be processed by a microprocessor, and be transmitted via transmitting media or telecommunication networks as computer data combined with carrier waves.

The media that can be processed by the microprocessor includes electronic circuits, semiconductor memory devices, ROMs, a flash memory, EEPROM, a floppy disk, optical disk, a hard disk, a optic fiber, a wireless network, and other, all of which can transfer and store information. Additionally, computer data includes data that can be transferred through electrical network channel, optic fiber, an electromagnetic field, and a wireless network.

It should be understood by those of ordinary skill in the art that various replacement, modifications and changes in the form and details may be made therein without departing from the sprit and scope of the present invention as defined by the following claims. Therefore, it is to be appreciated that the above described embodiments are for purpose of illustration only and are not to be construed as limitations of the invention.

What is claimed is:

1. A plasma display panel driving circuit, comprising:
a scan-up unit for providing a reference voltage of a scan pulse to a particular node;
a scan-down unit for providing a scan voltage of the scan pulse to the node; and
a scan driver for supplying the scan pulse, which is formed with the reference voltage and the scan voltage applied to the node, to a plurality of Y electrodes of a plasma display panel, the scan driver including a plurality of switching elements for providing the scan voltage to the Y electrodes in accordance with a control signal, and a diode for supplying the reference voltage to the Y electrodes.

2. The plasma display panel driving circuit of claim 1, wherein the diode is coupled in parallel to the switching elements.

3. The plasma display panel driving circuit of claim 1, wherein the scan driver includes at least one integrated circuit (IC) coupled to at least one of the plurality of Y electrodes.

4. The plasma display panel driving circuit of claim 3, wherein at least one of the switching elements includes an N-type metal oxide semiconductor (MOS) transistor or an insulated gate bipolar transistor (IGBT).

5. The plasma display panel driving circuit of claim 3, wherein the diode is an independent circuit in one area on the integrated circuit, or the diode is formed parasitically when designing the switching elements.

6. The plasma display panel driving circuit of claim 1, wherein the scan-up unit includes a switching element that operates based on a control signal to enable the reference voltage to be applied to the node.

7. The plasma display panel driving circuit of claim 6, wherein the scan-up unit further includes an element for blocking a current flowing in a direction opposite to a direction in which the reference voltage is applied, the element blocking the current by applying a voltage higher than the reference voltage to the node.

8. The plasma display panel driving circuit of claim 1, wherein the scan-down unit includes a switching element to enable the scan voltage to be applied to the node.

9. The plasma display panel driving circuit of claim 1, wherein the reference voltage is approximately 10 volts or 0 volts.

10. The plasma display panel driving circuit of claim 1, wherein the switching elements are provided between the node and each Y electrode, and different voltage levels of the scan pulse are applied to each of the plurality of Y electrodes via the switching elements.

11. The plasma display panel driving circuit of claim 1, wherein the reference voltage is greater than the scan voltage.

12. The plasma display panel driving circuit of claim 11, wherein the scan pulse is applied to the Y electrodes during a scan period.

13. A plasma display panel driving circuit comprising:
a scan-up unit for providing a reference voltage, the reference voltage corresponding to one voltage level of a scan pulse that is supplied to a plurality of Y electrodes of a plasma display panel;
a scan-down unit for providing a scan voltage, the scan voltage corresponding to one voltage level of the scan pulse in a period corresponding to the lower voltage level; and
a plurality of switching elements for selectively outputting scan pulses based on the reference voltage and scan voltage, the scan pulses being applied to the plurality of Y electrodes in response to a control signal.

14. The plasma display panel driving circuit of claim 13, wherein the plurality of switching elements include at least one integrated circuit.

15. The plasma display panel driving circuit of claim 13, wherein at least one of the switching elements includes an N-type metal oxide semiconductor (MOS) transistor or an insulated gate bipolar transistor (IGBT).

16. The plasma display panel driving circuit of claim 13, wherein at least one of the switching elements selectively applies the reference voltage or the scan voltage to the Y electrodes in response to the control signal in a scan pulse period.

17. The plasma display panel driving circuit of claim 13, wherein the reference voltage is greater than the scan voltage.

18. The plasma display panel driving circuit of claim 13, wherein each Y electrode corresponds to only of the switching elements.

19. A scan drive circuit connected to at least one Y electrode of a plasma display panel for supplying a set-up voltage, a sustain pulse and a scan pulse to the at least one Y electrode, the scan drive circuit comprising:
at least one diode for forming a path for the set-up voltage, the sustain pulse, and a reference voltage of the scan pulse; and
at least one switching element, connected in parallel to the at least one diode, for forming the scan pulse in a scan period by switching to a scan voltage of the scan pulse in accordance with a control signal.

20. The scan drive circuit of claim 19, wherein the at least one switching element and the at least one diode are integrated on one semiconductor chip.

21. The scan drive circuit of claim 19, wherein the reference voltage is greater than the scan voltage.

22. A plasma display driving method comprising:
providing a reference voltage to a node;
providing a scan voltage to the node;
forming a scan pulse based on the reference voltage and the scan voltage; and
applying the formed scan pulse to at least one electrode of a plasma display panel during a scan period.

23. The plasma display driving method of claim 22, further comprising:
forming another scan pulse based on the reference voltage and the scan voltage; and
applying the formed another scan pulse to at least another electrode.

24. The plasma display driving method of claim 22, wherein forming the scan pulse comprises switching to the scan voltage based on a control signal.

25. The plasma display driving method of claim 22, providing the reference voltage includes providing the reference voltage to the node based on a control signal.

26. The plasma display driving method of claim 22, further comprising blocking the reference voltage from the node.

27. The plasma display driving method of claim 22, wherein the reference voltage is greater than the scan voltage.
